(19) United States
(12) Patent Application Publication
(10) Pub. No.: US 2008/0233307 A1
(43) Pub. Date: Sep. 25, 2008

(54) Photocurable inkjet ink

(75) Inventors: Hiroyuki Satou, Ichihara-shi (JP); Hisanobu Minamisawa, Ichihara-shi (JP)

Correspondence Address: HOGAN & HARTSON LLP;IP GROUP, COLUMBIA SQUARE, 555 THIRTEENTH STREET, N.W., WASHINGTON, DC, 20004, US

(73) Assignee: CHISSO Corporation

(21) Appl. No.: 12/068,456

(22) Filed: Feb. 6, 2008

(30) Foreign Application Priority Data
Feb. 9, 2007 (JP) 030057/2007
Nov. 27, 2007 (JP) 305776/2007

(51) Int. Cl. C08J 3/28; C09D 11/10

(52) U.S. Cl. 427/511; 522/64

(57) ABSTRACT

There is a need for a photocurable inkjet ink capable of being cured with low light energy and of forming ultrafine patterns. There is also a need for the formation of films having the flexibility to be formed even on flexible boards using photocurable inkjet ink. The invention provides a photocurable inkjet ink including a photopolymerization initiator and a polymerizable monomer having a thermosetting functional group.

### CROSS REFERENCE TO RELATED APPLICATIONS

This application claims priority under 35 U.S.C. §119 to Japanese Patent Application Nos. JP 2007-030057 (filed Feb. 9, 2007) and 2007-305776 (filed Nov. 27, 2007), each of which applications is expressly incorporated herein by reference in its entirety.

### BACKGROUND OF THE INVENTION

1. Field of the Invention

The invention relates to a photocurable inkjet ink, and more particularly relates to a photocurable inkjet ink to be used in the manufacture of liquid crystal display elements, EL display elements, printed wiring boards and the like. The invention also relates to an ink application method using a photocurable inkjet ink, to a cured film and method for forming a cured film obtained from a photocurable inkjet ink, and to an electronic circuit board wherein cured film is formed.

2. Description of the Related Art

Patterned cured films are used, for example, in many parts of liquid crystal display elements, including spacers, insulating films, protective films and the like, and many photocurable compositions have already been proposed for this purpose (see, for example, Japanese Patent Application Laid-Open No. 2004-287232). The most common method of preparing a patterned cured film using a photocurable composition is photolithography, in which ultraviolet rays are shined through a mask having the desired pattern, and the part not exposed to the ultraviolet rays are removed by development.

However, this method requires a specialized production line having an exposure unit, a development unit and the like, so the equipment investment is considerable.

Under these circumstances, the inkjet method has been proposed in recent years because it requires less capital investment, does not involve developing fluid, and uses materials more efficiently among other advantages, and compositions (inkjet inks) have also been proposed for use in this method (see, for example, Japanese Patent Application Laid-Open No. 2003-302642). Photocurable inkjet inks have also been proposed for use in the inkjet method (see, for example, WO 2004/099272, pamphlet and Japanese Patent Applications Laid-Open Nos. 2006-282757 and 2006-307152).

In general, the ultraviolet rays emitted by an extra-high pressure mercury lamp are used as the exposure light for curing a photocurable inkjet ink in the inkjet method, but there has been recent research into the use of LED light sources, which offer the advantages of high energy efficiency and inexpensive equipment.

The problem is that while conventional inkjet inks are highly sensitive to the ultraviolet rays (wavelength approximately 365 nm) emitted by extra-high pressure mercury lamps, they are not sufficiently sensitive to the ultraviolet rays (wavelength approximately 395 nm to approximately 420 nm) from LED light sources.

Thus, when a conventional inkjet ink is exposed to ultraviolet rays from an LED light source, the ink is not cured sufficiently and the liquid spreads after the ink droplets hit the substrate, so that an ultrafine pattern cannot be formed.

### SUMMARY OF THE INVENTION

In view of the foregoing, there is a need for photocurable inkjet inks that are curable (highly sensitive) with low light energy. There is also a need for photocurable inkjet inks capable of forming ultrafine patterns.

There is also a need for the formation of films having flexibility that allows them to be formed even on flexible boards using curable inkjet inks.

Based on these needs, a photocurable inkjet ink including a photopolymerization initiator having a specific structure and a photopolymerizable monomer having a specific structure has been developed.

The invention provides the following:

[1] A photocurable inkjet ink, including a photopolymerization initiator represented by Formula (2) or Formula (3) below:

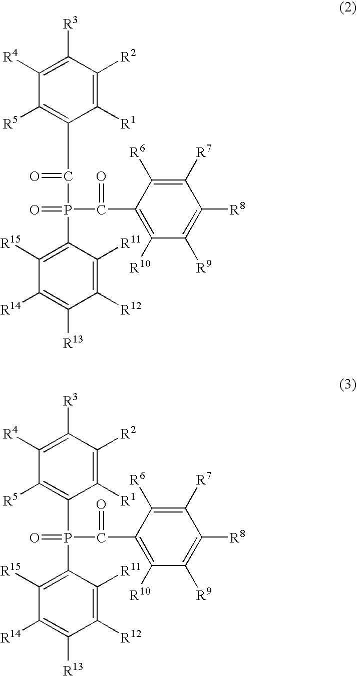

wherein each of R¹ through R¹⁵ independently represents a hydrogen, a C₁₋₅ alkyl or an optionally substituted phenyl; and
a polymerizable monomer having a thermosetting functional group.

[2] The photocurable inkjet ink according to item [1], wherein each of R¹ through R¹⁵ in Formula (2) and Formula (3) independently represents hydrogen or a C₁₋₃ alkyl.

[3] The photocurable inkjet ink according to items [1] or [2], wherein the thermosetting functional group is one or more selected from hydroxy, carboxyl, amino, alkoxy, oxirane and oxetane groups.

[4] The photocurable inkjet ink according to any of items [1] through [3], wherein the polymerizable monomer having a thermosetting functional group is a monomer having one radical-polymerizable double bond.

[5] The photocurable inkjet ink according to any of items [1] through [4], wherein the polymerizable monomer having a thermosetting functional group is a compound represented by Formula (11) below:

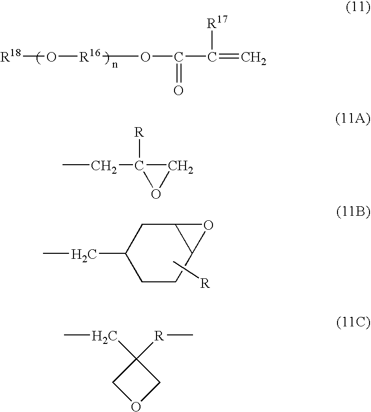

wherein Formula (11), R¹⁶ is a C₂₋₁₂ alkylene optionally having a ring structure, R¹⁷ is a C₁₋₃ alkyl or hydrogen, n is an integer from 0 to 30, and R¹⁸ is a hydrogen or a group represented by any of Formulae (11A) through (11C); and in Formulae (11A) through (11C), each R independently represents a hydrogen or C₁₋₅ alkyl;
or a compound represented by Formula (12) below:

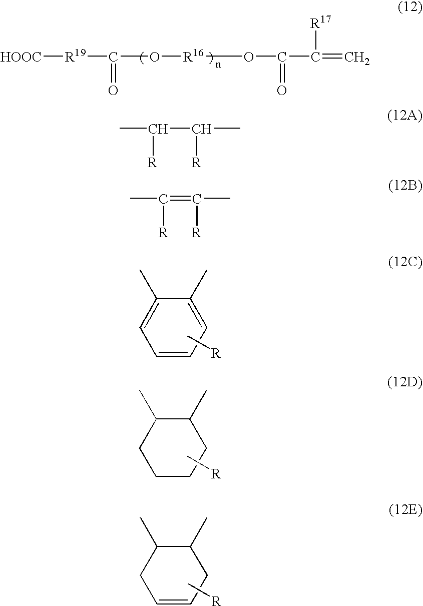

wherein Formula (12), R¹⁶ is a C₂₋₁₂ alkylene optionally having a ring structure, R¹⁷ is a C₁₋₃ alkyl or hydrogen, n is an integer from 1 to 30 and R¹⁹ is any of groups represented by Formulae (12A) through (12E); and in Formulae (12A) through (12E), each R is independently a hydrogen or C₁₋₅ alkyl.

[6] The photocurable inkjet ink according to item [5], wherein in Formula (11), R¹⁶ is an ethylene, propylene or butylene or a group represented by Formula (B) below, R¹⁷ is a hydrogen or methyl, n is an integer from 1 to 5 and R¹⁸ is a hydrogen, while in Formula (12), R¹⁶ is an ethylene, propylene, butylene or a group represented by Formula (B) below, R¹⁷ is a hydrogen or methyl, n is an integer from 1 to 5 and R¹⁹ is any of groups represented by Formulae (12A) through (12E), and in Formulae (12A) through (12E) each R independently represents a hydrogen or methyl:

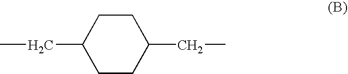

[7] A photocurable inkjet ink including a photopolymerization initiator represented by the following Formula (2):

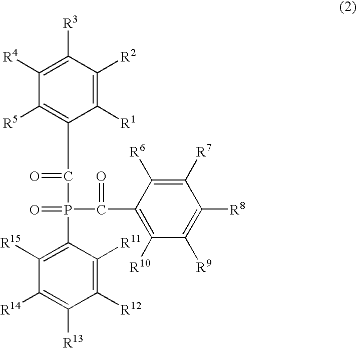

wherein Formula (2), R¹, R³, R⁵, R⁶, R⁸ and R¹⁰ are methyl and R², R⁴, R⁷, R⁹, R¹¹, R¹², R¹³, R¹⁴ and R¹⁵ are hydrogen or the following Formula (3):

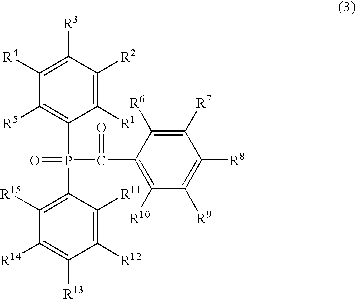

wherein Formula (3), R⁶, R⁸ and R¹⁰ are methyl and R¹, R², R³, R⁴, R⁵, R⁷, R⁹, R¹¹, R¹², R¹³, R¹⁴ and R¹⁵ are hydrogen;
and including one or more polymerizable monomers selected from the group of 2-hydroxyethyl(meth)acrylate, 2-hydroxypropyl(meth)acrylate, 4-hydroxybutyl(meth)acrylate, cyclohexane dimethanol mono(meth)acrylate, 2-(meth)acryloyloxyethyl succinic acid, 2-(meth)acryloyloxyethyl maleic acid, 2-(meth)acryloyloxyethyl phthalic acid, 2-(meth)acryloyloxyethylhexahydrophthalic acid, and 2-(meth)acryloyloxyethyl tetrahydrophthalic acid.

[8] The photocurable inkjet ink according to any of items [1] through [7], further including a bifunctional (meth)acrylate.

[9] The photocurable inkjet ink according to item [8], wherein the bifunctional (meth)acrylate is one or more selected from the group of bisphenol F ethylene oxide-modified di(meth)acrylate, bisphenol A ethylene oxide-modified di(meth)acrylate, isocyanuric ethylene oxide modified di(meth)acrylate, 1,4-butanediol di(meth)acrylate, 1,6-hexanediol di(meth)acrylate and 2,2-dimethyl-1,3-propanediol di(meth)acrylate.

[10] The photocurable inkjet ink according to any of items [1] through [9], further including an alkenyl substituted nadiimide compound.

[11] The photocurable inkjet ink according to item [10], wherein the alkenyl substituted nadiimide compound (A) is a compound represented by the following Formula (20):

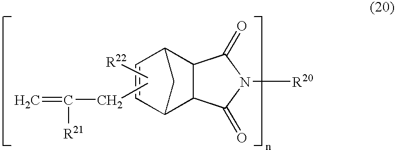

wherein Formula (20), R²¹ and R²² are each independently a hydrogen, C₁₋₁₂ alkyl, C₃₋₆ alkenyl, C₅₋₈ cycloalkyl, C₆₋₁₂ aryl or benzyl, R₂₀ is a C₁₋₃₀₀ organic group, and n is an integer from 1 to 4.

[12] The photocurable inkjet ink according to item [10], wherein the alkenyl substituted nadiimide compound is a compound represented by the following Formula (21):

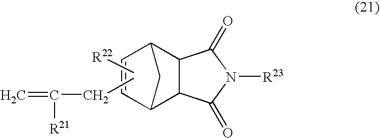

wherein Formula (21), R²¹ and R²² are each independently a hydrogen, C₁₋₁₂ alkyl, C₃₋₆ alkenyl, C₅₋₈ cycloalkyl, C₆₋₁₂ aryl or benzyl, and R²³ is a hydrogen, C₁₋₁₂ alkyl, C₁₋₁₂ hydroxyalkyl, C₅₋₈ cycloalkyl, C₆₋₁₂ aryl, benzyl, a group represented by —{(CH₂)_{q}Oₜ(CH₂)ᵣOᵤ(CH₂)ₛX, wherein q, r and s are each independently integers from 2 to 6, t is an integer 0 or 1, u is an integer from 1 to 30, and X is hydrogen or —OH, a group represented by —(R)ₐ—C₆H₄—R₄, wherein a is an integer 0 or 1, R is a C₁₋₄ alkylene, and R⁴ is hydrogen or a C₁₋₄ alkyl, a group represented by the following formula (A):

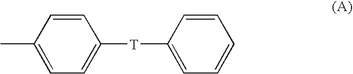

wherein T is —CH₂—, —C(CH₃)₂—, —CO—, —S— or —SO₂—, or a group which is one of these groups with —OH groups substituted for 1 to 3 hydrogens directly bound to aromatic rings.

[13] The photocurable inkjet ink according to item [10], wherein the alkenyl substituted nadiimide compound is a compound represented by the following Formula (22):

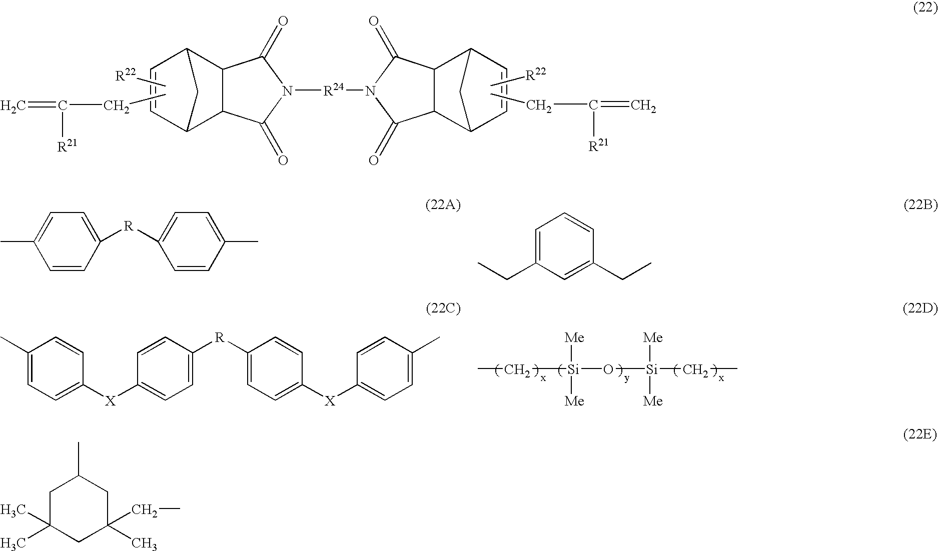

wherein Formula (22), R²¹ and R²² are each independently hydrogen or C₁₋₆ alkyls, and R²⁴ is a C₂₋₁₅ alkylene, wherein any methylene groups not adjacent to one another in the alkylene may be replaced by —O— or —CH═CH—, and any hydrogen may be replaced by fluorine, a group represented by Formula (22A), a group represented by Formula (22B), a group represented by Formula (22C), a group represented by Formula (22D) or a group represented by Formula (22E); and in Formulae (22A) and (22C), R is —CH₂—, —CH₂CH₂—, —O—, —C(CH₃)₂—, —C(CF₃)₂— or —SO₂—; and in Formulae (22C), each X is independently —CH₂— or —O—; and in Formulae (22D), each x is independently an integer from 1 to 6, while y is an integer from 1 to 70.

[14] The photocurable inkjet ink according to item [10], wherein the alkenyl substituted nadiimide compound is a compound represented by the following Formula (23):

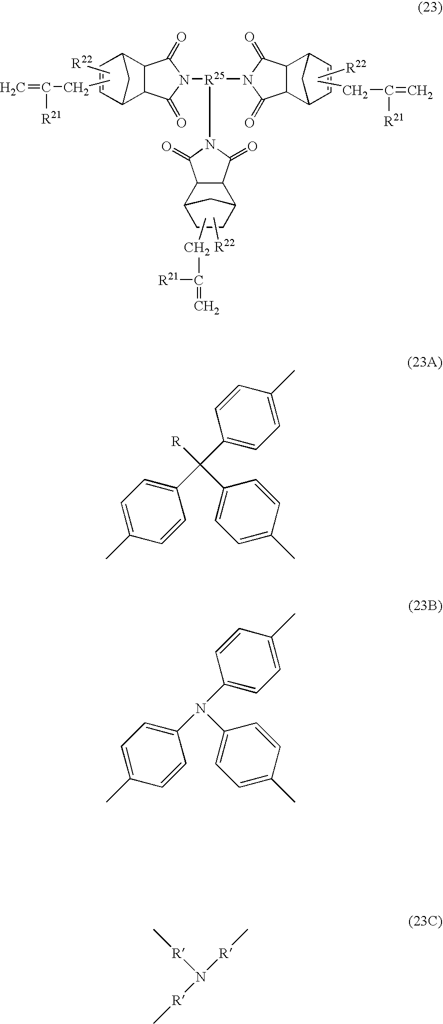

wherein Formula (23), R²¹ and R²² are each independently hydrogen or C₁₋₆ alkyls, and R²⁵ is a group represented by Formula (23A), a group represented by Formula (23B) or a group represented by Formula (23C); and in Formula (23A), R is a C₁₋₁₀ alkyl or —OH; and in Formula (23C), each R′ is independently a 1,2-ethylene or 1,4-butylene.

[15] The photocurable inkjet ink according to item [10], wherein the alkenyl substituted nadiimide compound is a compound represented by the following Formula (24):

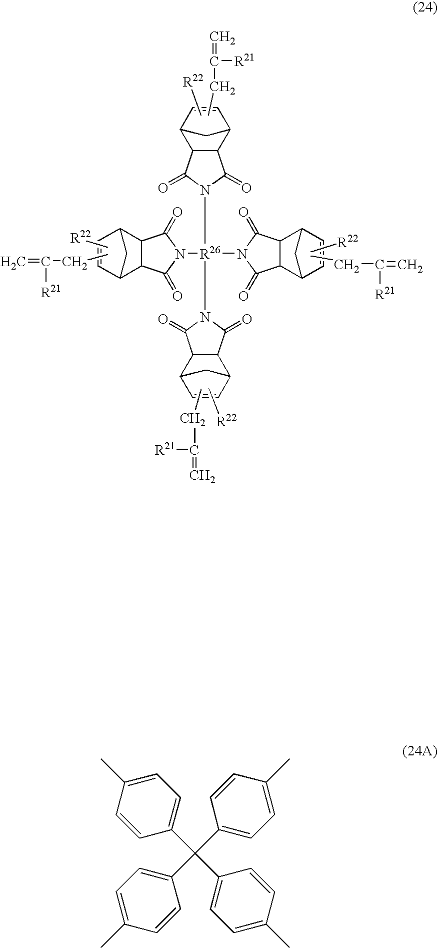

wherein Formula (24), R²¹ and R²²are each independently hydrogen or C₁₋₆ alkyls, and R²⁶ is the group represented by Formula (24A).

[16] The photocurable inkjet ink according to item [10], wherein the alkenyl substituted nadiimide compound is a compound obtained by reacting a monoamine, diamine, triamine or tetraamine with a compound represented by the following Formula (25):

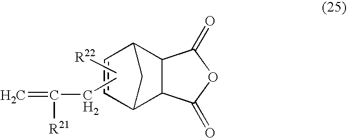

wherein Formula (25), R¹ and R² are each independently hydrogen, C₁₋₁₂ alkyls, C₃₋₆ alkenyls, C₅₋₈ cycloalkyls, C₆₋₁₂ aryls or benzyls.

[17] The photocurable inkjet ink according to any of items [1] through [16], further including at least one kind of bismaleimide compound.

[18] The photocurable inkjet ink according to item [17], wherein the bismaleimide compound is a compound represented by the following Formula (30):

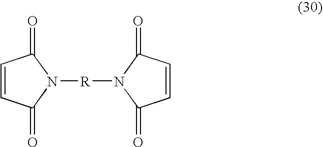

wherein Formula (30), R is a C₂₋₃₀ bivalent organic group. In Formula (30), R is preferably optionally substituted C₆₋₃₀ arylene group or C₆₋₃₀ polyarylene (—O— or C₁₋₅ alkylene may exist between each arylenes).

[19] The photocurable inkjet ink according to item [18], wherein R in Formula (30) is selected from the group of groups represented by the following formulae:

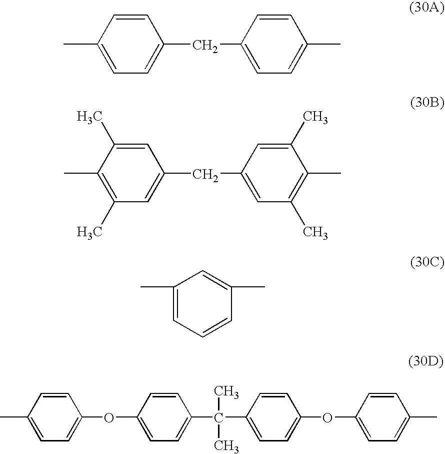

[20] The photocurable inkjet ink according to any of items [1] through [19], further including an epoxy resin.

[21] The photocurable inkjet ink according to item [20], wherein the epoxy resin is a compound represented by the following Formula (4):

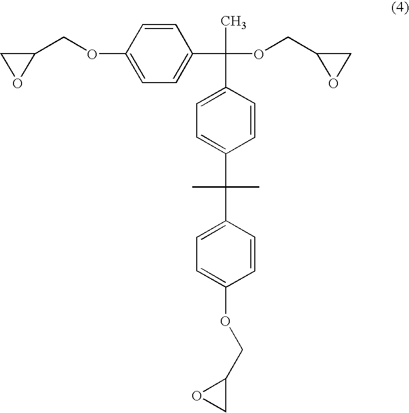

[22] An ink application method including a step of applying a photocurable inkjet ink according to any of items [1] through [21] by an inkjet application method and drying the same to form a coated film, and a step of exposing that coated film to light to form a cured film.

[23] A cured film forming method of forming a cured film in use of the ink application method according to item [22].

[24] An electronic circuit board including a cured film formed on a substrate using the cured film forming method according to item [23].

[25] An electronic component having the electronic circuit board according to item [24].

[26] A display element having a cured film formed using the method according to item [23].

The term “(meth)acrylate” is used in the Specification when both acrylate and methacrylate are intended.

In the Specification, a “C₁₋₃₀₀ organic group” is not particularly limited, but may for example be an optionally substituted hydrocarbon with 1 to 300 carbon atoms.

Specific examples of organic groups included the optionally substituted C₂₋₂₀ alkoxy groups, optionally substituted C₆₋₂₀ aryloxy groups, optionally substituted amino groups, optionally substituted silyl groups, optionally substituted alkylthio groups (—SY¹, wherein Y¹ represents an optionally substituted C₂₋₂₀ alkyl), optionally substituted arylthio groups (—SY², wherein Y² represents an optionally substituted C₆₋₁₈ aryl), optionally substituted alkylsulfonyl groups (—SO₂Y³, wherein Y³ represents an optionally substituted C₂₋₂₀ alkyl) and optionally substituted arylsulfonyl groups (—SO₂Y⁴, wherein Y⁴ represents an optionally substituted C₆₋₁₈ aryl).

In the Specification, a “C₁₋₁₂ alkyl” is preferably a C₁₋₁₀ alkyl, and more preferably a C₁₋₆ alkyl. Examples of alkyls include methyl, ethyl, propyl, isopropyl, n-butyl, s-butyl, t-butyl, pentyl, hexyl, dodecanyl and the like, but are not limited to these.

In the Specification, examples of “C₃-6 alkenyls” include vinyl, allyl, propenyl, isopropenyl, 2-methyl-1-propenyl, 2-methylallyl, 2-butenyl and the like, but are not limited to these.

In the Specification, examples of “C₅₋₈ cycloalkyls” include cyclopropyl, cyclobutyl, cyclopentyl, cyclohexyl and the like, but are not limited to these.

In the Specification, examples of “C₆₋₁₂ aryls” include phenyl, 1-naphthyl, 2-naphthyl, indenyl, biphenylyl, anthryl, phenanthryl and the like, but are not limited to these.

An inkjet ink of a preferred embodiment of the invention is, for example, relatively sensitive to ultraviolet rays at a wavelength of approximately 395 nm, and has small drop spreading after impact when dischargeed from an inkjet head. An ultrafine pattern can therefore be formed using an inkjet ink of a preferred embodiment of the invention.

A cured film that is flexible enough to be formed on a flexible board can also be formed using the inkjet ink of a preferred embodiment of the invention.

### DETAILED DESCRIPTION OF THE INVENTION

1. Photocurable Inkjet Ink of the Invention

The photocurable inkjet ink of the invention is a photocurable inkjet ink including at least a photopolymerization initiator that is at least one compound represented by Formula (2) or Formula (3) above, and a hydroxy-containing polymerizable monomer.

The photocurable inkjet ink of the invention is not particularly limited as long as it includes a photopolymerization initiator that is at least one compound represented by Formula (2) or Formula (3) above and a hydroxy-containing polymerizable monomer, and can be obtained by further mixing and dissolved an epoxy resin, solvent, polymerization inhibitor, alkali-soluble polymer, colorants and the like.

1.1 Photopolymerization Initiator

The photocurable inkjet ink of the invention includes a photopolymerization initiator that is at least one compound represented by Formula (2) or Formula (3) above.

In Formula (2) or Formula (3) above, R¹ through R¹⁵ each independently represent hydrogen, a C₁₋₅ alkyl or an optionally substituted phenyl.

Examples of the “C₁₋₅ alkyl” in the Specification include methyl, ethyl, propyl, isopropyl, n-butyl, s-butyl, t-butyl, pentyl and the like but are not limited to these.

Examples of substituents in the “optionally substituted phenyl” include C₁₋₁₀ hydrocarbons (for example, methyl, ethyl, propyl, butyl, phenyl, naphthyl, indenyl, tolyl, xylyl, benzyl and the like) C₁-C₁₀ alkoxies (for example, methoxy, ethoxy, propoxy, butoxy and the like), C₆-C₁₀ aryloxies (for example, phenyloxy, naphthyloxy, biphenyloxy and the like), and amino, —OH, halogen (for example, fluorine, chlorine, bromine, iodine) and silyl groups, but are not limited to these. In this case, 1 or more substituents may be introduced at substitutable positions, and preferably 1 through 4 may be introduced. When there are 2 or more substituents, they may be the same or different.

A photopolymerization initiator used in the invention may be one compound or a mixture of 2 or more different compounds. Consequently, a photopolymerization initiator used in the invention may be a mixture of 2 or more different compounds represented by Formula (2), or a mixture of 2 or more different compounds represented by Formula (3).

A photopolymerization initiator used in the invention may also include compounds other than those of Formula (2) or (3) as photopolymerization initiators. That is, the compound represented by Formula (2) or (3) and another compound may be used together as photopolymerization initiators in the inkjet ink of the invention.

Specific examples of photopolymerization initiators that can be used in combination with the compound of Formula (2) or (3) include benzophenone, Michler's ketone, 4,4′-bis(diethylamino)benzophenone, xanthone, thioxanthone, isopropylxanthone, 2,4-diethylthioxanthone, 2-ethylanthraquinone, acetophenone, 2-hydroxy-2-methylpropiophenone, 2-hydroxy-2-methyl-4′-isopropylpropiophenone, 1-hydroxycyclohexylphenyl ketone, isopropylbenzoin ether, isobutylbenzoin ether, 2,2-diethoxyacetophenone, 2,2-dimethoxy-2-phenylacetophenone, camphorquinone, benzanthrone, 2-methyl-1-[4-(methylthio)phenyl]-2-morpholinopropan-1-one, ethyl 2-benzyl-2-dimethylamino-1-(4-morpholinophenyl)-butanon-1,4-dimethylamino benzoate, isoamyl 4-dimethylamino benzoate, 4,4′-di(t-butylperoxycarbonyl) benzophenone, 3,4,4′-tri(t-butylperoxycarbonyl)benzophenone, 2-(4′-methoxystyryl)-4,6-bis(trichloromethyl)-s-triazine, 2-(3′,4′dimethoxystyryl)-4,6-bis(trichloromethyl)-s-triazine, 2-(2′,4′-dimethoxystyryl)-4,6-bis(trichloromethyl)-s-triazine, 2-(2′-methoxystyryl)-4,6-bis (trichloromethyl)-s-triazine, 2-(4′-pentyloxystyryl)-4,6-bis(trichloromethyl)-s-triazine, 4-[p-N,N-di(ethoxycarbonylmethyl)]-2,6-di(trichloromethyl)-s-triazine, 1,3-bis(trichloromethyl)-5-(2′-chlorophenyl)-s-triazine, 1,3-bis(trichloromethyl)-5-(4′-methoxyphenyl)-s-triazine, 2-(p-imethylaminostyryl)benzoxazole, 2-(p-dimethylaminostyryl)benzothiazole, 2-mercapto benzothiazole, 3,3′-carbonylbis(7-diethylaminocoumarin), 2-(o-chlorophenyl)-4,4′,5,5′-tetraphenyl-1,2′-biindazole, 2,2′-bis(2-chlorophenyl)-4,4′,5,5′-tetrakis(4-ethoxycarbonyl phenyl)-1,2′-biimidazole, 2,2′-bis(2,4-dichlorophenyl)-4,4′,5,5′-tetraphenyl-1,2′-biimidazole, 2,2′-bis(2,4-dibromophenyl)-4,4′,5,5′-tetraphenyl-1,2′-biimidazole, 2,2′-bis(2,4,6-trichlorophenyl)-4,4′,5,5′-tetraphenyl-1,2′-biimdazole, 3-(2-methyl-2-dimethylamino propionyl)carbazole, 3,6-bis(2-methyl-2-morpholinopropionyl)-9-n-dodecylcarbazole, 1-hydroxycyclohexylphenyl ketone, bis(η⁵-2,4-cyclopentadien-1-yl)-bis(2,6-difluoro-3-(1H-pyrrole-1-yl)-phenyl)titanium and the like.

Including the photopolymerization initiator in the amount of approximately 1 to approximately 50 pts. wt. per 100 pts. wt. of polymerizable monomer in the invention is desirable for achieving high sensitivity of the photocurable inkjet ink of the invention. Including the photopolymerization initiator in the amount of approximately 3 to approximately 40 pts wt per 100 pts wt of polymerizable monomer is still more desirable for increasing the flexibility of a pattern formed from the photocurable inkjet ink of the invention.

The proportion of the compound represented by Formula (2) or Formula (3) in the photopolymerization initiator contained in the photocurable inkjet ink of the invention is preferably approximately 20 wt % or more in order to achieve high sensitivity to ultraviolet rays at wavelengths of approximately 395 to approximately 420 nm, and more preferably the proportion is approximately 50 wt % or more.

1.2 Polymerizable Monomer of the Invention

The polymerizable monomer contained in the photocurable inkjet ink of the invention is not particularly limited as long as it includes a polymerizable compound having a thermosetting functional group.

The polymerizable monomer having a thermosetting functional group that must be included in the photocurable inkjet ink of the invention preferably has at least 1 functional group (including carbon-carbon double bonds and carbon-carbon triple bonds), and of these it preferably has 1 or more carbon-carbon double bonds or carbon-carbon triple bonds.

The thermosetting functional group is preferably 1 or more selected from the hydroxy, carboxyl, amino, alkoxy, oxirane and oxetane groups, and of these, a hydroxy or carboxyl group is preferred.

The polymerizable monomer having a hydroxy group as a thermosetting functional group that is contained in a photocurable inkjet ink of the invention is preferably a monomer having 1 radical-polymerizable double bond, and more preferably a polymerizable monomer having 1 carbon-carbon double bond. Specific examples of polymerizable monomers having a hydroxy group and 1 carbon-carbon double bond include 2-hydroxyethyl(meth)acrylate, 2-hydroxypropyl(meth)acrylate, 4-hydroxybutyl(meth)acrylate, 1,4-cyclohexane dimethanolmono(meth)acrylate and the like.

Specific examples of the polymerizable monomer having a hydroxy group as a thermosetting functional group and 2 carbon-carbon double bonds that is contained in a photocurable inkjet ink of the invention include isocyanuric ethylene oxide-modified di(meth)acrylate, pentaerythritol di(meth)acrylate, pentaerythritol di(meth)acrylate monostearate, trimethylol propane di(meth)acrylate, dipentaerythritol di(meth)acrylate and the like.

Specific examples of the polymerizable monomer having a hydroxy group as a thermosetting functional group and 3 or more carbon-carbon double bonds that is contained in a photocurable inkjet ink of the invention include pentaerythritol tri(meth)acrylate, dipentaerythritol penta(meth)acrylate, alkyl-modified dipentaerythritol penta(meth)acrylate, alkyl-modified dipentaerythritol tetra(meth)acrylate, alkyl-modified dipentaerythritol tri(meth)acrylate and the like.

Of these polymerizable monomers having hydroxy groups as thermosetting functional groups, better adhesiveness on a substrate and greater flexibility of a pattern formed from the photocurable inkjet ink are obtained using 2-hydroxyethyl(meth)acrylate, 2-hydroxypropyl(meth)acrylate, 4-hydroxybutyl(meth)acrylate or 1,4-cyclohexane dimethanolmono(meth)acrylate.

Specific examples of the polymerizable monomer having a carboxyl group as a thermosetting functional group that is included in a photocurable inkjet ink of the invention include 2-acryloyloxyethyl phthalic acid, 2-acryloyloxyethyl maleic acid and the like.

The polymerizable monomer having a thermosetting functional group that is used in the invention may include 1 monomer or a mixture of 2 or more monomers. For example, the polymerizable monomer having a thermosetting functional group that is used in the invention may be a mixture of a polymerizable monomer having a hydroxy and a polymerizable monomer having a thermosetting functional group other than a hydroxy (such as a carboxyl).

1.3 Bifunctional (meth)acrylate

The photocurable inkjet ink of the invention may further contain a bifunctional (meth)acrylate.

When the photocurable inkjet ink of the invention contains, as a polymerizable monomer, a bifunctional (meth)acrylate which is a polymerizable monomer having 2 carbon-carbon double bonds, the ink will be highly sensitive to ultraviolet rays at wavelengths of approximately 395 to approximately 420 nm, and a cured film obtained by curing the ink will be flexible. It is especially desirable for the photocurable inkjet ink to contain as polymerizable monomers both a bifunctional (meth)acrylate and a monomer having a hydroxy group and 1 radical-polymerizable double bond.

In the photocurable inkjet ink of the invention, specific examples of bifunctional (meth)acrylates that are preferred for use together with the polymerizable monomer having a thermosetting functional group include bisphenol F ethylene oxide-modified diacrylate, bisphenol A ethylene oxide-modified diacrylate, 1,6-hexanediol diacrylate and the like. The bifunctional (meth)acrylate preferably constitutes approximately 20 to approximately 80 wt % of the total polymerizable monomers in order to achieve a good balance between sensitivity and flexibility.

It is also desirable to use polymerizable monomers including a compound having 3 or more carbon-carbon double bonds in addition to the bifunctional (meth)acrylate and polymerizable monomer having a thermosetting functional group in the photocurable inkjet ink in order to achieve even greater sensitivity of the ink to ultraviolet rays at wavelengths of approximately 395 to approximately 420 nm. It is desirable that the compound having 3 or more carbon-carbon double bonds constitute approximately 10 to approximately 50 wt % of the total polymerizable monomers in order to achieve both sensitivity and flexibility of the resulting inkjet ink.

1.4 Alkenyl-Substituted Nadiimide Compound

The photocurable inkjet ink of the invention may also contain an alkenyl-substituted nadiimide compound.

The alkenyl-substituted nadiimide compound can be synthesized by known methods, and can be synthesized for example by reacting monoamine, diamine, triamine or tetraamine with the compound represented by Formula (25) above.

The alkenyl-substituted nadiimide compound preferably constitutes approximately 5 to approximately 50 wt % of the total polymerizable monomers in order to give the resulting cured film greater heat resistance and insulating properties.

1.5 Bismaleimide Compound

The photocurable inkjet ink of the invention may also contain a bismaleimide compound. Specific examples of the bismaleimide compound contained in the photocurable inkjet ink of the invention include m-phenylene bismaleimide, 4,4′-diphenylmethane bismaleimide and the like.

The bismaleimide compound preferably constitutes approximately 5 to approximately 50 wt % of the total polymerizable monomers in order to give the resulting cured film greater heat resistance and insulating properties.

1.6 Epoxy Resin

The photocurable inkjet ink of the invention may also contain an epoxy resin. Including an epoxy resin in the inkjet ink is desirable for improving the durability of a cured film obtained by curing the ink.

The epoxy resin used in the invention is not particularly limited as long as it has an oxirane, but preferably has 2 or more oxiranes.

Specific examples of epoxy resins that can be used in the invention include bisphenol A epoxy resins, glycidyl ester epoxy resins, alicyclic epoxy resins and the like. Specific examples of such epoxy resins include Epikote 807, Epikote 815, Epikote 825, Epikote 827, Epikote 828, Epikote 190P and Epikote 191 P (the above are product names of Yuka Shell Epoxy), Epikote 1004 and Epikote 1256 (the above are product names of Japan Epoxy Resin Co., Ltd.), Araldite CY177 and Araldite CY184 (the above are product names of Ciba Geigy, Inc.), Ceroxide 2021P and EHPE-3150 (the above are product names of Daicel Chemical Industries) and the compound represented by Formula (4) above (Techmore VG3101L which is product name of Mitsui Chemical Corporation) and the like.

Of these, the compound represented by Formula (4) is preferred because it provides the curable inkjet ink of the invention with good discharge properties.

The epoxy resin preferably constitutes approximately 1 to approximately 50 pts wt per 100 pts wt of the polymerizable moner for purposes of improving the durability of a cured film obtained by curing the photocurable inkjet ink of the invention.

1.7 Other Components

The photocurable inkjet ink of the invention can also contain solvents, polymerization inhibitors, alkali-soluble polymers, colorants and the like in order to improve the discharge properties and storage stability of the ink and the durability and the like of a film formed therefrom.

One such compound or a mixture of 2 or more different compounds may be used.

1.7.1 Solvents

The photocurable inkjet ink of the invention may contain a solvent for improving the discharge properties of the ink. A solvent contained in the photocurable inkjet ink of the invention is preferably one with a boiling point of approximately 100° C. or more.

Specific examples of solvents with boiling points of approximately 100° C. or more include water, butyl acetate, butyl propionate, ethyl lactate, methyl oxyacetate, ethyl oxyacetate, butyl oxyacetate, methyl methoxyacetate, ethyl methoxyacetate, butyl methoxyacetate, methyl ethoxyacetate, ethyl ethoxyacetate, methyl 3-oxypropionate, ethyl 3-oxypropionate, methyl 3-methoxypropionate, ethyl 3-methoxypropionate, methyl 3-ethoxypropionate, ethyl 3-ethoxypropionate, methyl 2-oxypropionate, ethyl 2-oxypropionate, propyl 2-oxypropionate, methyl 2-methoxypropionate, ethyl 2-methoxypropionate, propyl 2-methoxypropionate, methyl 2-ethoxypropionate, ethyl 2-ethoxypropionate, methyl 2-oxy-2-methylpropionate, ethyl 2-oxy-2-methylpropionate, methyl 2-methoxy-2-methylpropionate, ethyl 2-ethoxy-2-methylpropionate, methyl pyruvate, ethyl pyruvate, propyl pyruvate, methyl acetoactate, ethyl acetoacetate, methyl 2-oxobutanoate, ethyl 2-oxobutanoate, dioxane, ethylene glycol, diethylene glycol, triethylene glycol, propylene glycol, dipropylene glycol, tripropylene glycol, 1,4-butanediol, ethylene glycol monoisopropyl ether, ethylene glycol monobutyl ether, propylene glycol monomethyl ether, propylene glycol monomethyl ether acetate, propylene glycol monoethyl ether acetate, propylene glycol monopropyl ether acetate, dipropylene glycol monoethyl ether acetate, dipropylene glycol monobutyl ether acetate, ethylene glycol monobutyl ether acetate, cyclohexanone, cyclopentanone, diethylene glycol monomethyl ether, diethylene glycol monomethyl ether acetate, diethylene glycol monoethyl ether, diethylene glycol monoethyl ether acetate, diethylene glycol monobutyl ether, diethylene glycol monobutyl ether acetate, diethylene glycol dimethyl ether, diethylene glycol diethyl ether, diethylene glycol methyl ethyl ether, toluene, xylene, anisole, γ-butyrolactone, N,N-dimethylacetamide, N-methyl-2-pyrrolidone, dimethylimidazolidinone and the like.

Of these solvents, dipropylene glycol monoethyl ether acetate, dipropylene glycol monobutyl ether acetate, propylene glycol monomethyl ether acetate, propylene glycol monoethyl ether acetate, methyl 3-methoxypropionate, ethyl 3-ethoxypropionate, diethylene glycol monoethyl ether acetate, diethylene glycol monobutyl ether acetate, diethylene glycol dimethyl ether, diethylene glycol methyl ethyl ether and the like are preferred for stabilizing discharge of the ink.

One compound or a mixture of 2 or more different compounds can be used for the solvent.

In the photocurable inkjet ink of the invention, the solvent is preferably contained so that the solids concentration does not fall below approximately 20 wt %.

1.7.2 Polymerization Inhibitor

A polymerization inhibitor may be included in the photocurable inkjet ink of the invention in order to improve storage stability.

Specific examples of polymerization inhibitors include 4-methoxyphenol, hydroquinone, phenothiazine and the like. Of these, phenothiazine is preferably used as the polymerization inhibitor in order to minimize changes in viscosity of the ink that occur when the inkjet head is heated during jetting.

One compound or a mixture of 2 or more different compounds may be used for the polymerization inhibitor.

The polymerization inhibitor is preferably added in the amount of approximately 0.01 to approximately 1 pts wt per 100 pts wt of the polymerizable monomer in order to achieve both high sensitivity and storage stability of the ink.

1.7.3 Alkali-Soluble Polymer

The photocurable inkjet ink of the invention may also contain an alkali-soluble polymer.

A photocurable inkjet ink containing an alkali-soluble polymer can be used for example as an etching resist so that the pattern can be stripped with alkali after inkjet patterning and etching treatment of the areas other than the pattern.

The alkali-soluble polymer used in the invention is not particularly limited as long as approximately 0.1 g or more of the polymer dissolves in 100 g of 5 wt % NaOH aqueous solution at approximately 50° C., but a polymer of a radical-polymerizable monomer having carboxyl groups or a copolymer of a radical-polymerizable monomer having carboxyl groups with another radical-polymerizable monomer is preferred.

Specific examples of alkali-soluble polymers include benzyl methacrylate/methacrylic acid copolymer, benzyl methacrylate/2-hydroxyethyl methacrylate/methacrylic acid copolymer, benzyl methacrylate/5-tetrahydrofurfuryl oxycarbonyl pentyl(meth)acrylate/2-hydroxyethyl methacrylate/methacrylic acid copolymer, and ring-opened styrene/anhydrous maleic acid copolymer and the like. Of these, a photocurable inkjet ink having benzyl methacrylate/5-tetrahydrofurfuryl oxycarbonyl pentyl(meth)acrylate/2-hydroxyethyl methacrylate/methacrylic acid copolymer added thereto is desirable for etching resist use in preparing electronic circuit boards because a cured film formed from this ink is highly acid resistant and can easily be removed with an alkali solution.

In order to give a cured film formed from the ink the properties of high acid resistance and removability with alkali solution, the photocurable inkjet ink of the invention preferably contains the alkali-soluble polymer in the amount of approximately 10 to approximately 100 pts wt per 100 pts wt of polymerizable monomer.

1.7.4 Colorant

The photocurable inkjet ink of the invention may also contain a colorant in the amount of approximately 1 to approximately 50 pts wt per 100 pts wt of polymerizable monomer in order to make the cured film easier to distinguish from the substrate when the condition of a cured film formed from the photocurable inkjet ink is inspected.

From the standpoint of heat resistance of a cured film formed from the photocurable inkjet ink, the colorant is preferably a pigment.

1.8 Photocurable Inkjet Ink Preparation Method

The photocurable inkjet ink of the invention is preferably prepared by filtering a solution obtained by mixing the necessary components. A fluorine resin membrane filter or the like can be used for filtration.

1.9 Viscosity of Photocurable Inkjet Ink

The photocurable inkjet ink of the invention preferably has a viscosity of approximately 3 to approximately 300 mPa·s at approximately 25° C. in order to obtain good discharge properties. When the viscosity at approximately 25° C. exceeds approximately 20 mPa·s, stable discharge can be achieved by heating the inkjet head to reduce the viscosity during discharge.

1.10 Storage of Photocurable Inkjet Ink

The photocurable inkjet ink of the invention has good storage stability and changes little in viscosity when stored at approximately −20 to approximately 20° C.

2 Application of Inkjet Ink by Inkjet Method

The photocurable inkjet ink of the invention can be used in an inkjet application method having a step of application by a known inkjet method. Examples of inkjet application methods include a method of applying mechanical energy to the ink to thereby apply the ink, and a method of applying thermal energy to the ink to thereby apply the ink.

The inkjet ink can be applied in a pre-determined pattern using an inkjet application method. In this way, costs are reduced because the ink is applied only to the necessary areas.

A preferred application unit for applying an ink of the invention can be an application unit including, for example, an ink container part for containing the ink, and an application head. The application unit can, for example, be an application unit that applies thermal energy to the ink in response to an application signal to thereby produce ink droplets by means of such energy.

The application head has, for example, a heating element with a liquid contact surface containing a metal and/or metal oxide. Specific examples of this metal and/or metal oxide include Ta, Zr, Ti, Ni, Al and other metals and oxides of these metals and the like.

An example of a preferred application device for applying the ink of the invention is a device which applies energy in response to an application signal to an ink in the chamber of an application head having an ink container containing the ink to thereby produce ink droplets by means of that energy.

The application head and ink container need not be separate in the inkjet application device, but may integrated into one inseparable unit. The ink container may be integrated either separably or inseparably with the application head and mounted on a carriage, or may be provided on a fixed site on the device, in which case the ink is supplied to the application head via an ink supply member such as a tube.

3. Formation of Cured Film

The cured film of the invention is obtained by first discharging the inkjet ink of the invention onto the surface of a substrate using a known inkjet application method, and then exposing the ink to light such as ultraviolet or visible light. The ink in the area exposed to light becomes a three-dimensional crosslinked body by polymerization of the acrylic monomers, thereby curing the ink and effectively preventing its spread. Consequently, ultrafine patterns can be drawn using the inkjet ink of the invention. Depending on the composition of the inkjet ink, when ultraviolet rays are used, the amount of ultraviolet rays are preferably approximately 10 to approximately 1,000 mJ/cm² as measured using a Ushio Denki UIT-201 integrated light meter with attached UVD-405PD photodetector.

The ink may also be heated and baked as necessary after having been discharged on the surface of the substrate and exposed to light, and it is especially desirable to heat it for approximately 10 to approximately 60 minutes at 120 to 250° C.

In the Specification, a “substrate” is not particularly limited as long as the inkjet ink of the invention is applied thereto, and may be curved as well as flat.

The material of a substrate used in the invention is also not particularly limited, and examples include polyethylene terephthalate (PET), polybutylene terephthalate (PBT) and other polyester resins, polyethylene, polypropylene and other polyolefin resins, polyvinyl chloride, fluorine resin, acrylic resin, polyamide, polycarbonate, polyimide and other plastic films, cellophane, acetate, metal foil, laminated films of polyimide and metal foil, glassine paper with a filling effect, parchment paper or paper filled with polyethylene, clay binder, polyvinyl alcohol, starch, carboxymethyl cellulose (CMC) or the like or glass or the like. Additives such as pigments, dyes, anti-oxidants, preservatives, fillers, ultraviolet absorbers, anti-static agents and/or anti-electromagnetic agents can also be included in the materials making up these substrate to the extent that they do not detract from the effects of the invention.

The thickness of the substrate is not particularly limited, and is normally approximately 10 μm to approximately 2 mm and can be adjusted as necessary according to the object, but a thickness of approximately 15 to approximately 500 μm is preferable and approximately 20 to approximately 200 μm is more preferable.

The surface for forming the cured film on the substrate can as necessary be given an adhesion-promoting treatment such as corona treatment, plasma treatment, blast treatment or the like, and may also be given an adhesion-promoting layer.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

### Example 1

4-hydroxybutyl acrylate as the polymerizable monomer having a hydroxy and 1 double carbon-carbon bond, bisphenol A ethylene oxide-modified diacrylate (Aronix (product name) M210 of Toagosei, hereunder called “M210”) as the polymerizable monomer having a hydroxy and 2 carbon-carbon double bonds, bis(2,4,6-trimethylbenzoyl)-phenylphosphine oxide (Irgacure (product name) 819 of Ciba Specialty Chemicals, hereunder called “1819”) as the photopolymerization initiator, Techmore (product name) VG3101L of Mitsui Chemical (hereunder called “VG3101L”) as the epoxy resin and phenothiazine as the polymerization inhibitor were mixed and dissolved in the following proportions to obtain a photocurable inkjet ink.

“I819” is the compound of Formula (2) in which R¹, R³, R⁵, R⁶, R⁸ and R¹⁰ are methyls and R², R⁴, R⁷, R⁹, R¹¹, R¹², R¹³, R¹⁴ and R¹⁵ are hydrogen.

| | |
|---|---|
| 4-hydroxybutyl acrylate | 100.00 g |
| M210 | 100.00 g |
| I819 | 10.00 g |
| VG3101L | 20.00 g |
| Phenothiazine | 0.05 g |

A solution obtained in this way was filtered with a 0.2 μm fluorine resin membrane filter to prepare a photocurable inkjet ink.

This photocurable inkjet ink was injected into an inkjet cartridge, which was then mounted on a DMP-2811 (product name) Dimatix inkjet unit, and lines were drawn on the polyimide film Capton® (Toray-Dupont, 150 μm thick, H type, hereunder called “Capton substrate”) with the space between lines increased from 20 μm to 200 μm in 10 μm increments, to a film thickness of 5 μm. The drawings conditions were set so that the width of the lines would be the same as the distance between lines. In the Specification, this kind of drawing is called “line & space application.” The ink was applied once, with a line length of 50 mm, a jetting rate of 10 times a second from the nozzle and a jetting temperature of 60° C.

After completion of drawing, this substrate was exposed to light using a Topcon TME-400PRC proximity exposure unit. Light with a wavelength of 380 nm or less and 420 nm or more was cut through a wavelength cut filter, and 405 nm ultraviolet rays were extracted and used for exposure. The amount of exposure was 30 mJ/cm² as measured with a Ushio Denki UIT-201 integrated light meter with attached UVD-405PD photodetector. This substrate was then baked for 30 minutes at 160° C. to obtain a Capton substrate with a pattern formed thereon by line & space application (hereunder called the “line & space pattern”). When this substrate was observed under a microscope, the spaces in the 20 to 40 μm line and space pattern obtained by line and space application were filled in by the spreading of the liquid, but it was possible to draw line and space patterns of 50 μm or more. When this substrate was rolled into a cylinder 5 mm in radius with the drawn surface on the inside and observed under a microscope, no cracks appeared in the line and space pattern.

### Example 2

A photocurable inkjet ink was obtained by mixing and dissolving the following composition as in Example 1 except that 2,4,6-trimethylbenzoyl-diphenylphosphine oxide (Darocur (product name) TPO of Chiba Specialty Chemicals Ltd, hereunder called “TPO”) was used as the photopolymerization initiator.

“TPO” is the compound of Formula (3) in which R⁶, R⁸ and R¹⁰ are methyls and R¹, R², R³, R⁴, R⁵, R⁷R⁹, R¹¹, R¹², R¹³, R¹⁴ and R¹⁵ are hydrogen.

| | |
|---|---|
| 4-hydroxybutyl acrylate | 100.00 g |
| M210 | 100.00 g |
| TPO | 10.00 g |
| VG3101L | 20.00 g |
| Phenothiazine | 0.05 g |

The solution obtained in this way was filtered with a 0.2 μm fluorine resin membrane filter to prepare a photocurable inkjet ink.

A Capton substrate with a line & space pattern formed thereon was obtained by the same operations as in Example 1 using this photocurable inkjet ink. When this substrate was observed under a microscope, the spaces in the line & space pattern obtained by 20 to 40 μm line and space application were filled in by the spreading of the liquid, but it was possible to draw line and space patterns of 50 μm or more. When this substrate was rolled into a cylinder 5 mm in radius with the drawn surface on the inside and observed under a microscope, no cracks appeared in the line and space pattern.

### Example 3

4-hydroxybutyl acrylate as the polymerizable monomer having a hydroxy and 1 carbon-carbon double bond, 2-acryloyloxyethyl phthalic acid as the polymerizable monomer having a carboxyl and 1 carbon-carbon double bond, 1,6-hexanediol diacrylate as the bifunctional (meth)acrylate, TPO as the photopolymerization initiator, bis{4-(allylbicyclo[2.2.1 ]hepto-5-en-2,3-dicarboxyimide)phenyl}methane (hereunder “BANIM”) as the alkenyl-substituted nadiimide compound and phenothiazine as the polymerization inhibitor were mixed and dissolved in the following proportions to obtain a photocurable inkjet ink.

| | |
|---|---|
| 4-hydroxybutyl acrylate | 50.00 g |
| 2-acryloyloxyethyl phthalic acid | 50.00 g |
| 1,6-hexanediol diacrylate | 100.00 g |
| TPO | 10.00 g |
| VG3101L | 10.00 g |
| BANIM | 10.00 g |
| Phenothiazine | 0.05 g |

The resulting solution was filtered with an 0.2 μm fluorine resin membrane filter to prepare a photocurable inkjet ink.

A Capton substrate with a line and space pattern formed thereon was obtained by the same operations as in Example 1 using this photocurable inkjet ink. When this substrate was observed under a microscope, the spaces in the 20 to 40 μm line and space pattern obtained by line and space application were filled in by the spreading of the liquid, but it was possible to draw line and space patterns of 50 μm or more. When this substrate was rolled into a cylinder 5 mm in radius with the drawn surface on the inside and observed under a microscope, no cracks appeared in the line and space pattern.

Comparative Example 1

The following components were mixed and dissolved to obtain a photocurable inkjet ink as in Example 1 except that 2-benzyl-2-dimethylamino-1-(4-morpholinophenyl)-butanon-1 (Irgacure (product name) 369 of Ciba Specialty Chemicals, hereunder called “I369”) was used as the photopolymerization initiator.

I369 is an α-aminoalkylphenone compound.

| | |
|---|---|
| 4-hydroxybutyl acrylate | 100.00 g |
| M210 | 100.00 g |
| I369 | 10.00 g |
| VG3101L | 20.00 g |
| Phenothiazine | 0.05 g |

The solution thus obtained was filtered with a 0.2 μm fluorine resin membrane filter to obtain a photocurable ink.

A Capton substrate with a line & space pattern formed thereon was obtained by the same operations as in Example 1 using this photocurable inkjet ink. When this substrate was observed under a microscope, the spaces in the line and space patterns obtained by 20 to 150 μm line and space application were filled in by the spreading of the liquid, but it was possible to draw line and space patterns of 160 μm or more. When this substrate was rolled into a cylinder 5 mm in radius with the drawn surface on the inside and observed under a microscope, no cracks appeared in the line and space pattern.

### INDUSTRIAL APPLICABILITY

The photocurable inkjet ink of the invention can be used for example for etching resists and protective films for electronic circuit boards, spacers and protective films for liquid crystal displays and insulating films for flexible wiring boards, and in electronic components using these.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A photocurable inkjet ink, comprising a photopolymerization initiator represented by Formula (2) or Formula (3): 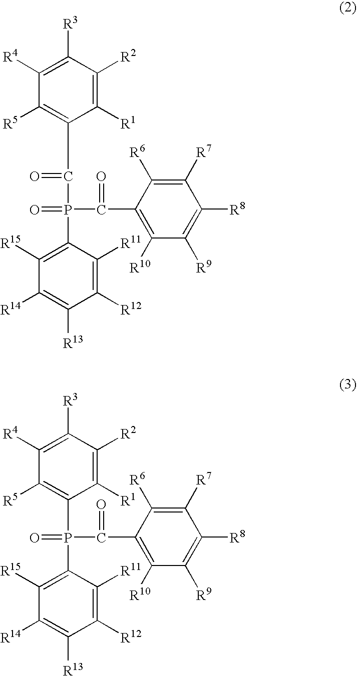
wherein each of R¹ through R¹⁵ independently represents a hydrogen, a C₁₋₅ alkyl or an optionally substituted phenyl); and
a polymerizable monomer having a thermosetting functional group.

2. The photocurable inkjet ink according to claim 1, wherein each of R¹ through R¹⁵ in Formula (2) and Formula (3) independently represents at least one of a hydrogen and a C₁₋₃ alkyl.

3. The photocurable inkjet ink according to claim 1, wherein the thermosetting functional group is one or more selected from hydroxy, carboxyl, amino, alkoxy, oxirane and oxetane groups.

4. The photocurable inkjet ink according to claim 1, wherein the polymerizable monomer having a thermosetting functional group is a monomer having one radical-polymerizable double bond.

5. The photocurable inkjet ink according to claim 1, wherein the polymerizable monomer having a thermosetting functional group is a compound represented by Formula (11): 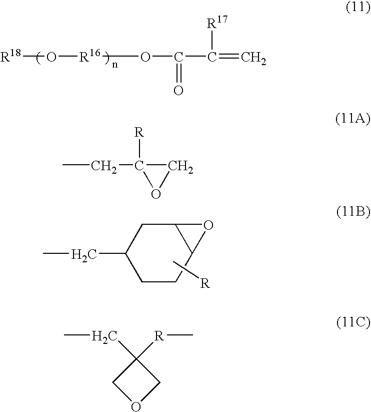
wherein Formula (11), R¹⁶ is a C₂₋₁₂ alkylene optionally having a ring structure, R¹⁷ is a C₁₋₃ alkyl or hydrogen, n is an integer from 0 to 30, and R¹⁸ is a hydrogen or a group represented by any of Formulae (11A) through (11C); and in Formulae (11A) through (11C), each R independently represents a hydrogen or C₁₋₅ alkyl);
or a compound represented by Formula (12): 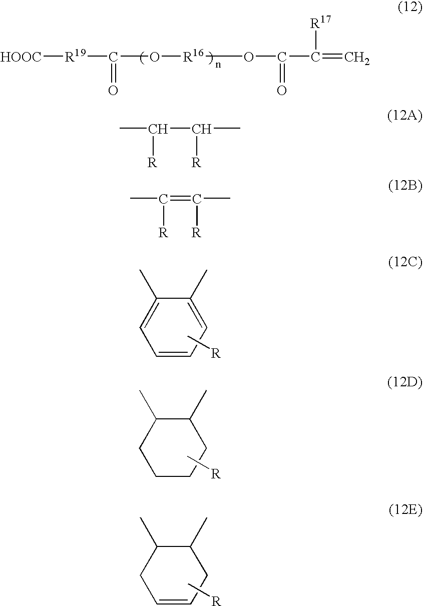
wherein Formula (12), R¹⁶ is a C₂₋₁₂ alkylene optionally having a ring structure, R¹⁷ is a C₁₋₃ alkyl or hydrogen, n is an integer from 1 to 30 and R¹⁹ is any of groups represented by Formulae (12A) through (12E); and in Formulae (12A) through (12E), each R is independently a hydrogen or C₁₋₅ alkyl.

6. The photocurable inkjet ink according to claim 5, wherein in Formula (11), R¹⁶ is an ethylene, propylene or butylene or a group represented by Formula (B) below, R¹⁷ is a hydrogen or methyl, n is an integer from 1 to 5 and R¹⁸ is a hydrogen;. and
wherein Formula (12), R¹⁶ is an ethylene, propylene, butylene or a group represented by Formula (B), 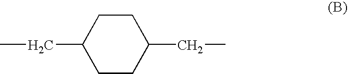
R¹⁷ is a hydrogen or methyl, n is an integer from 1 to 5 and R¹⁹ is any of groups represented by Formulae (12A) through (12E), and in Formulae (12A) through (12E) each R independently represents a hydrogen or methyl.

7. A photocurable inkjet ink comprising a photopolymerization initiator represented by at least one of Formula (2): 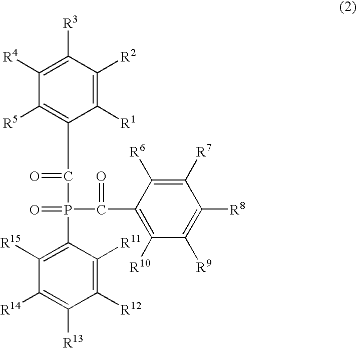
wherein Formula (2), R¹, R³, R⁵, R⁶, R⁸ and R¹⁰ are methyl and R², R⁴, R⁷, R⁹, R¹¹, R¹², R¹³, R¹⁴ and R¹⁵ are hydrogen; and
Formula (3): 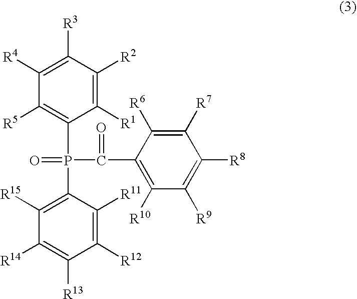
wherein Formula (3), R⁶, R⁸ and R¹⁰ are methyl and R¹, R², R³, R⁴, R⁵, R⁷, R⁹, R¹¹, R¹², R¹³, R¹⁴ and R¹⁵ are hydrogen;
and further comprising one or more polymerizable monomers selected from the group of 2-hydroxyethyl(meth)acrylate, 2-hydroxypropyl(meth)acrylate, 4-hydroxybutyl(meth)acrylate, cyclohexane dimethanol mono(meth)acrylate, 2-(meth)acryloyloxyethyl succinic acid, 2-(meth)acryloyloxyethyl maleic acid, 2-(meth)acryloyloxyethyl phthalic acid, 2-(meth)acryloyloxyethylhexahydrophthalic acid, and 2-(meth)acryloyloxyethyl tetrahydrophthalic acid.

8. The photocurable inkjet ink according to claim 1, further comprising a bifunctional (meth)acrylate.

9. The photocurable inkjet ink according to claim 8, wherein the bifunctional (meth)acrylate is one or more selected from the group of bisphenol F ethylene oxide-modified di(meth)acrylate, bisphenol A ethylene oxide-modified di(meth)acrylate, isocyanuric ethylene oxide modified di(meth)acrylate, 1,4-butanediol di(meth)acrylate, 1,6-hexanediol di(meth)acrylate and 2,2-dimethyl-1,3-propanediol di(meth)acrylate.

10. The photocurable inkjet ink according to claim 1, further comprising an alkenyl substituted nadiimide compound.

11. The photocurable inkjet ink according to claim 10, wherein the alkenyl substituted nadiimide compound is a compound represented by Formula (20): 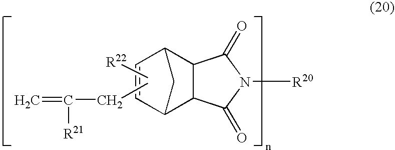
wherein Formula (20), R²¹ and R²² are each independently a hydrogen, a C₁₋₁₂ alkyl, C₃₋₆ alkenyl, a C₅₋₈ cycloalkyl, a C₆₋₁₂ aryl or a benzyl, R₂₀ is a C₁₋₃₀₀ organic group, and n is an integer from

12. The photocurable inkjet ink according to claim 10, wherein the alkenyl substituted nadiimide compound is a compound represented by Formula (21): 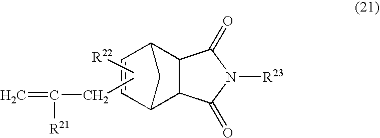
wherein Formula (21), R²¹ and R²² are each independently a hydrogen, a C₁₋₁₂ alkyl, a C₃₋₆ alkenyl, a C₅₋₈ cycloalkyl, a C₆₋₁₂ aryl or a benzyl, and R²³ is a hydrogen, C₁₋₁₂ alkyl, C₁₋₁₂ hydroxyalkyl, C₅₋₈ cycloalkyl, C₆₋₁₂ aryl, benzyl, a group represented by —{(CH₂)_{q}Oₜ(CH₂)ᵣOᵤ(CH₂)ₛX}, wherein q, r and s are each independently integers from 2 to 6, t is an integer 0 or 1, u is an integer from 1 to 30, and X is hydrogen or —OH, a group represented by —(R)ₐ—C₆H₄—R₄, wherein a is an integer 0 or 1, R is a C₁₋₄ alkylene, and R⁴ is hydrogen or a C₁₋₄ alkyl, a group represented by formula (A): 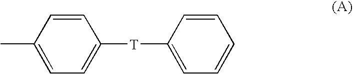
wherein T is —CH₂—, —C(CH₃)₂—, —CO—, —S— or —SO₂—, or any of the preceding groups with —OH groups substituted for 1 to 3 hydrogens directly bound to aromatic rings.

13. The photocurable inkjet ink according to claim 10, wherein the alkenyl substituted nadiimide compound is a compound represented by Formula (22): 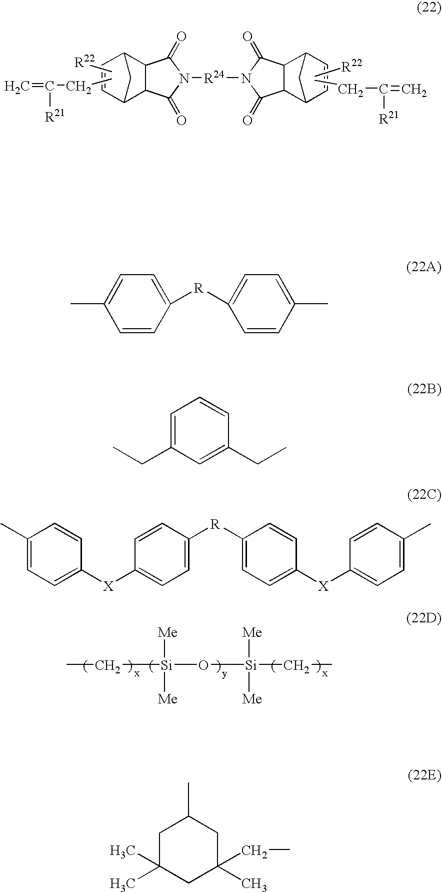
wherein Formula (22), R²¹ and R²² are each independently hydrogen or C₁₋₆ alkyls, and R²⁴ is a C₂₋₁₅ alkylene, wherein any methylene groups not adjacent to one another in the alkylene may be replaced by —O— or —CH═CH—, and any hydrogen may be replaced by fluorine, a group represented by Formula (22A), a group represented by Formula (22B), a group represented by Formula (22C), a group represented by Formula (22D) or a group represented by Formula (22E); wherein Formulae (22A) and (22C), R is —CH₂—, —CH₂CH₂—, —O—, —C(CH₃)₂—, —C(CF₃)₂— or —SO₂—; and wherein Formulae (22C), each X is independently —CH₂— or —O—; and wherein Formulae (22D), each x is independently an integer from 1 to 6, while y is an integer from 1 to 70.

14. The photocurable inkjet ink according to claim 10, wherein the alkenyl substituted nadiimide compound is a compound represented by Formula (23): 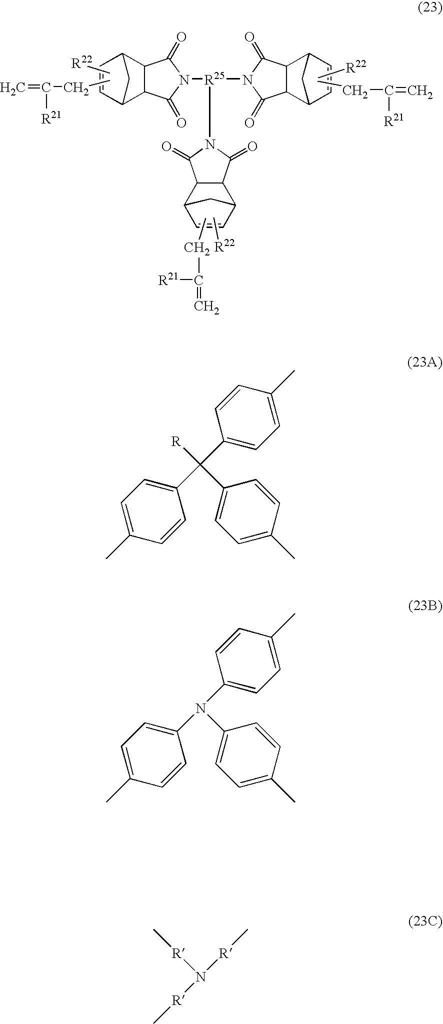
wherein Formula (23), R²¹ and R²² are each independently hydrogen or C₁₋₆ alkyls, and R²⁵ is a group represented by Formula (23A), a group represented by Formula (23B) or a group represented by Formula (23C); and wherein Formula (23A), R is a C₁₋₁₀ alkyl or —OH; and wherein Formula (23C), each R′ is independently a 1,2-ethylene or 1,4-butylene.

15. The photocurable inkjet ink according to claim 10, wherein the alkenyl substituted nadiimide compound is a compound represented by Formula (24): 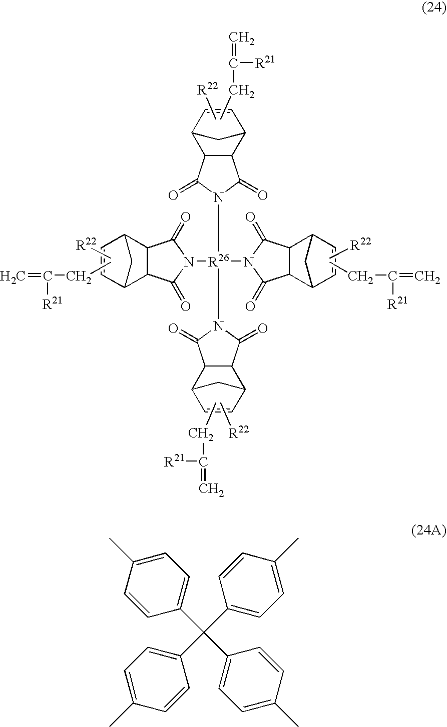
wherein Formula (24), R²¹ and R²² are each independently hydrogen or C₁₋₆ alkyls, and R²⁶ is the group represented by Formula (24A).

16. The photocurable inkjet ink according to claim 10, wherein the alkenyl substituted nadiimide compound is a compound obtained by reacting a monoamine, diamine, triamine or tetraamine with a compound represented by Formula (25): 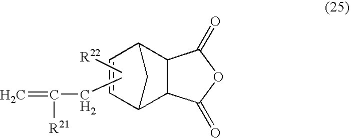
wherein Formula (25), R¹ and R² are each independently hydrogen, C₁₋₁₂ alkyls, C₃₋₆ alkenyls, C₅₋₈ cycloalkyls, C₆₋₁₂ aryls or benzyls.

17. The photocurable inkjet ink according to claim 1, further comprising at least one bismaleimide compound.

18. The photocurable inkjet ink according to claim 17, wherein the bismaleimide compound is a compound represented by Formula (30): 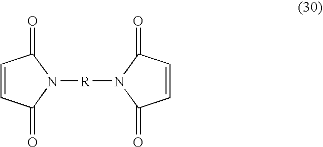
wherein Formula (30), R is a C₂₋₃₀ bivalent organic group.

19. The photocurable inkjet ink according to claim 18, wherein R in Formula (30) is at least one group represented by formulae 30A-30D:

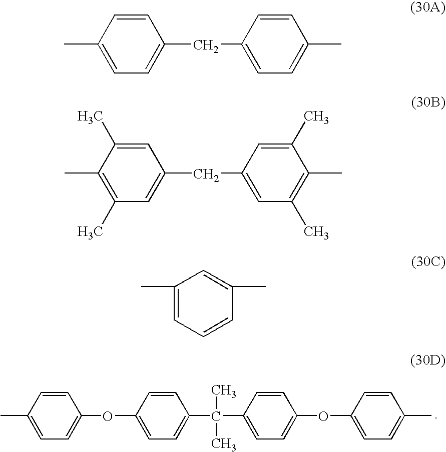

20. The photocurable inkjet ink according to claim 1, further comprising an epoxy resin.

21. The photocurable inkjet ink according to claim 20, wherein the epoxy resin is a compound represented by Formula (4):

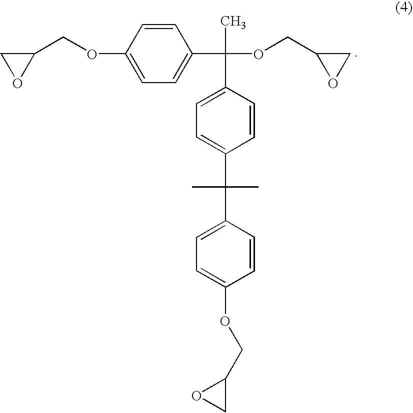

22. An ink application method comprising a step of applying a photocurable inkjet ink according to claim 1 by an inkjet application method and drying the same to form a coated film, and a step of exposing the coated film to light to form a cured film.

23. A cured film forming method comprising the ink application method according to claim 22.

24. An electronic circuit board comprising a cured film formed on a substrate using the cured film forming method according to claim 23.

25. An electronic component comprising the electronic circuit board according to claim 24.

26. A display element comprising a cured film formed using the method according to claim 23.
